(19) United States
(12) Patent Application Publication
(10) Pub. No.: US 2025/0117146 A1
(43) Pub. Date: Apr. 10, 2025

(54) STORAGE DEVICE EXECUTING SUDDEN POWER-OFF RECOVERY OPERATION FOR TARGET ZONE AND METHOD FOR OPERATING THE SAME

(71) Applicant: SK hynix Inc., Icheon-si (KR)

(72) Inventor: Jung Woo KIM, Icheon-si (KR)

(21) Appl. No.: 18/420,553

(22) Filed: Jan. 23, 2024

(30) Foreign Application Priority Data
Oct. 4, 2023 (KR) 10-2023-0131357

(51) Int. Cl. G06F 3/06

(52) U.S. Cl. CPC G06F 3/064; G06F 3/0619; G06F 3/0679

(57) ABSTRACT

A storage device may set a plurality of zones each of which includes one or more memory blocks among a plurality of memory blocks. When a sudden power-off is detected during a write operation for a target zone among the plurality of zones, the storage device may write dummy data to the target zone during a recovery operation for the sudden power-off. When writing data of a size matching that of the dummy data onto the target zone after the dummy data is written, the storage device may write the data to a target memory block in which is outside the target zone.

### CROSS-REFERENCE TO RELATED APPLICATION

The present application claims priority under 35 U.S.C. § 119(a) to Korean Patent Application No. 10-2023-0131357 filed in the Korean Intellectual Property Office on Oct. 4, 2023, which is incorporated herein by reference in its entirety.

### BACKGROUND

### 1. Technical Field

Various embodiments generally relate to a storage device which executes a sudden power-off recovery operation for a target zone, and a method for operating the storage device.

### 2. Related Art

A storage device is a device for storing data according to a request from an external device such as a computer, a mobile terminal (e.g., a smart phone or tablet), or the like.

A storage device may include a memory for storing data therein and a controller for controlling the memory. The memory may be a volatile memory or a non-volatile memory. The controller may receive a command from an external device (e.g., a host), and execute or control operations to read, write, or erase data in the memory according to the received command.

According to a request of the external device, the storage device may set a plurality of zones. The memory may include a plurality of memory blocks, and each of the plurality of memory blocks may be included in one of the plurality of zones.

### SUMMARY

Various embodiments of the disclosed technology are directed to providing a storage device capable of preventing the performance of a zone from degrading due to a sudden power-off, and a method for operating the same.

In one aspect, a storage device may include: i) a memory including a plurality of memory blocks, each of the plurality of memory blocks including a plurality of pages; and ii) a controller configured to set a plurality of zones, each of which includes one or more memory blocks among the plurality of memory blocks according to a request of a host, when a sudden power-off is detected during a writing operation for a target zone among the plurality of zones, write dummy data to the target zone during a recovery operation for the sudden power-off, and in response to a write request from the host for the target zone after the dummy data is written to the target zone, write data of a size matching that of the dummy data onto a target memory block, which is outside the target zone among the plurality of memory blocks.

In another aspect, a method for operating a storage device may include: i) setting a plurality of zones according to a request of a host, each of the plurality of zones including one or more memory blocks among a plurality of memory blocks included in the storage device; ii) detecting a sudden power-off during a writing operation for a target zone among the plurality of zones; iii) writing dummy data to the target zone during a recovery operation for the sudden power-off; iv) receiving, from the host, a write request for the target zone after the dummy data is written to the target zone; and v) writing, in response to the write request, data of a size matching that of the dummy data onto a target memory block, which is outside the target zone among the plurality of memory blocks.

According to the embodiments of the disclosed technology, it is possible to prevent the performance of a zone from degrading due to a sudden power-off.

### BRIEF DESCRIPTION OF THE DRAWINGS

FIG. 1 is a schematic configuration diagram of a storage device according to an embodiment of the present disclosure.

FIG. 2 is a block diagram schematically illustrating a memory of FIG. 1.

FIG. 3 is a diagram showing a schematic structure of a storage device according to an embodiment of the present disclosure.

FIG. 4 is a diagram showing an operation of detecting a sudden power-off according to an embodiment of the present disclosure.

FIG. 5 is a diagram showing an operation of writing dummy data during a recovery operation for a sudden power-off according to an embodiment of the present disclosure.

FIG. 6 is a diagram showing an operation of writing first data according to an embodiment of the present disclosure.

FIG. 7 is a diagram showing an operation of generating mapping information according to an embodiment of the present disclosure.

FIG. 8 is a diagram showing an operation of writing second data according to an embodiment of the present disclosure.

FIG. 9 is a diagram showing a method for operating a storage device according to an embodiment of the present disclosure.

### DETAILED DESCRIPTION

Hereinafter, embodiments of the present disclosure are described in detail with reference to the accompanying drawings. Throughout the specification, reference to “an embodiment,” “another embodiment,” or the like is not necessarily to only one embodiment, and different references to any such phrase are not necessarily limited to the same embodiment(s). The term “embodiments” when used herein does not necessarily refer to all embodiments.

Various embodiments of the present invention are described below in more detail with reference to the accompanying drawings. However, the present invention may be embodied in different forms and variations, and should not be construed as being limited to the embodiments set forth herein. Rather, the described embodiments are provided so that this disclosure will be thorough and complete, and will fully convey the present invention to those skilled in the art to which this invention pertains. Throughout the disclosure, like reference numerals refer to like parts throughout the various figures and embodiments of the present invention.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing methods herein.

When implemented at least partially in software, the controllers, processors, devices, modules, units, multiplexers, logic, interfaces, decoders, drivers, generators and other signal generating and signal processing features may include, for example, a memory or other storage device for storing code or instructions to be executed, for example, by a computer, processor, microprocessor, controller, or other signal processing device.

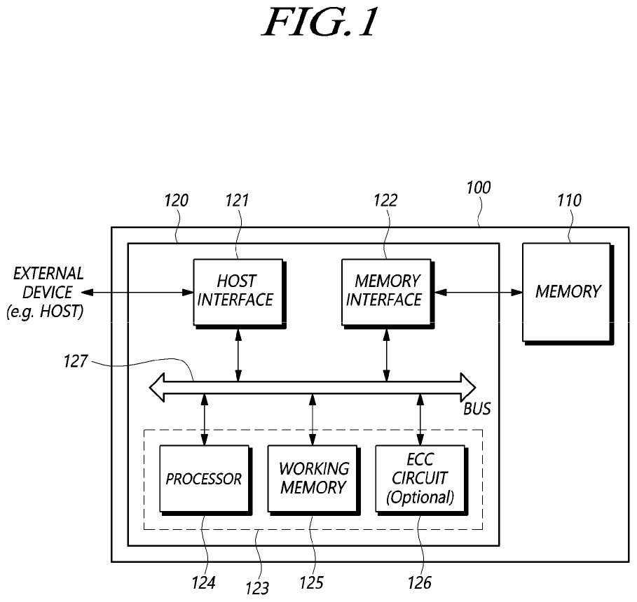

FIG. 1 is a schematic configuration diagram of a storage device 100 according to an embodiment of the present disclosure.

Referring to FIG. 1, the storage device 100 may include a memory 110 that stores data and a controller 120 that controls the memory 110.

The memory 110 includes a plurality of memory blocks, and operates under the control of the controller 120. Operations of the memory 110 may include a read operation, a program operation (also referred to as a write operation) and an erase operation.

The memory 110 may include a memory cell array including a plurality of memory cells (also simply referred to as “cells”) that store data.

For example, the memory 110 may be realized in various types of memory such as a DDR SDRAM (double data rate synchronous dynamic random access memory), an LPDDR4 (low power double data rate 4) SDRAM, a GDDR (graphics double data rate) SDRAM, an LPDDR (low power DDR) SDRAM, an RDRAM (Rambus dynamic random access memory), a NAND flash memory, a 3D NAND flash memory, a NOR flash memory, a resistive random access memory (RRAM), a phase-change memory (PRAM), a magnetoresistive random access memory (MRAM), a ferroelectric random access memory (FRAM), a spin transfer torque random access memory (STT-RAM), and the like.

The memory 110 may be implemented with a three-dimensional array structure. For example, embodiments of the present disclosure may be applied to a charge trap flash (CTF) memory in which a charge storage layer is configured by a dielectric layer and a flash memory in which a charge storage layer is configured by a conductive floating gate.

The memory 110 may receive a command and an address from the controller 120, and may access an area in the memory cell array that is selected by the address. In other words, the memory 110 may perform an operation, indicated by the command, on the area selected by the address.

The memory 110 may perform a program operation, a read operation, or an erase operation. For example, when performing the program operation, the memory 110 may program data to the area selected by the address. When performing the read operation, the memory 110 may read data from the area selected by the address. In the erase operation, the memory 110 may erase data stored in the area selected by the address.

The controller 120 may control write (or program), read, erase, and background operations for the memory 110. For example, background operations may include at least one from among a garbage collection (GC) operation, a wear leveling (WL) operation, a read reclaim (RR) operation, a bad block management (BBM) operation, and so forth.

The controller 120 may control the operation of the memory 110 according to a request from a device (e.g., a host) located outside the storage device 100. The controller 120, however, also may control the operation of the memory 110 regardless of a request of the host.

The host may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a computer network, one of various electronic devices configuring a telematics network, an RFID (radio frequency identification) device, and a mobility device (e.g., a vehicle, a robot, or a drone) capable of operating under human control or autonomous driving, as non-limiting examples. Alternatively, the host may be a virtual reality (VR) device providing 2D or 3D virtual reality images or an augmented reality (AR) device providing augmented reality images. The host may be any one of various electronic devices that require the storage device 100 capable of storing data.

The host may include at least one operating system (OS). The operating system may generally manage and control the function and operation of the host, and may control interoperability between the host and the storage device 100. The operating system may be classified into a general operating system and a mobile operating system depending on the mobility of the host.

The controller 120 and the host may be devices that are separated from each other, or the controller 120 and the host may be integrated into one device. Hereunder, for the sake of convenience in explanation, descriptions will describe the controller 120 and the host as devices that are separated from each other.

Referring to FIG. 1, the controller 120 may include a memory interface 122 and a control circuit 123, and may further include a host interface 121.

The host interface 121 provides an interface for communication with the host. For example, the host interface 121 provides an interface that uses at least one from among various interface protocols such as a USB (universal serial bus) protocol, an MMC (multimedia card) protocol, a PCI (peripheral component interconnection) protocol, a PCI-E (PCI-express) protocol, an ATA (advanced technology attachment) protocol, a serial-ATA protocol, a parallel-ATA protocol, an SCSI (small computer system interface) protocol, an ESDI (enhanced small disk interface) protocol, an IDE (integrated drive electronics) protocol, and a private protocol.

When receiving a command from the host, the control circuit 123 may receive the command through the host interface 121, and may perform an operation of processing the received command.

The memory interface 122 may be coupled with the memory 110 to provide an interface for communication with the memory 110. That is to say, the memory interface 122 may be configured to provide an interface between the memory 110 and the controller 120 under the control of the control circuit 123.

The control circuit 123 performs the general control operations of the controller 120 to control the operation of the memory 110. To this end, for instance, the control circuit 123 may include at least one of a processor 124 or a working memory 125, and may optionally include an error detection and correction circuit (ECC circuit) 126.

The processor 124 may control general operations of the controller 120, and may perform logical calculations. The processor 124 may communicate with the host through the host interface 121, and may communicate with the memory 110 through the memory interface 122.

The processor 124 may execute logical operations required to perform the function of a flash translation layer (FTL). The processor 124 may translate a logical block address (LBA), provided by the host, into a physical block address (PBA) through the flash translation layer. The flash translation layer may receive the logical block address and translate the logical block address into the physical block address, by using a mapping table.

There are various address mapping methods of the flash translation layer, depending on a mapping unit. Representative address mapping methods include a page mapping method, a block mapping method, and a hybrid mapping method.

The processor 124 may randomize data received from the host. For example, the processor 124 may randomize data received from the host by using a set randomizing seed. The randomized data may be provided to the memory 110, and may be programmed to a memory cell array of the memory 110.

In a read operation, the processor 124 may derandomize data received from the memory 110. For example, the processor 124 may derandomize data received from the memory 110 by using a derandomizing seed. The derandomized data may be outputted to the host.

The processor 124 may execute firmware to control the operation of the controller 120. Namely, in order to control the general operation of the controller 120 and perform a logical calculation, the processor 124 may execute (or drive) firmware loaded in the working memory 125 upon booting. Hereafter, an operation of the storage device 100 according to embodiments of the present disclosure will be described as implementing the processor 124 that executes firmware in which the corresponding operation is defined.

Firmware, as a program to be executed in the storage device 100 to drive the storage device 100, may include various functional layers. For example, the firmware may include binary data in which codes for executing the functional layers, respectively, are defined.

For example, the firmware may include at least one from among a flash translation layer, which performs a translating function between a logical address requested to the storage device 100 from the host and a physical address of the memory 110; a host interface layer (HIL), which serves to analyze a command requested to the storage device 100 from the host and transfer the command to the flash translation layer; and a flash interface layer (FIL), which transfers a command, instructed by the flash translation layer, to the memory 110.

Such firmware may be loaded in the working memory 125 from, for example, the memory 110 or a separate nonvolatile memory (e.g., a ROM or a NOR Flash) located outside the memory 110. The processor 124 may first load all or a part of the firmware in the working memory 125 when executing a booting operation after power-on.

The processor 124 may perform a logical calculation, which is defined in the firmware loaded in the working memory 125, to control the general operation of the controller 120. The processor 124 may store a result of performing the logical calculation defined in the firmware, in the working memory 125. The processor 124 may control the controller 120 according to a result of performing the logical calculation defined in the firmware such that the controller 120 generates a command or a signal. When a part of firmware, in which a logical calculation to be performed is defined, is stored in the memory 110, but not loaded in the working memory 125, the processor 124 may generate an event (e.g., an interrupt) for loading the corresponding part of the firmware into the working memory 125 from the memory 110.

The processor 124 may load metadata necessary for driving firmware from the memory 110. The metadata, as data for managing the memory 110, may include management information on user data stored in the memory 110.

Firmware may be updated during the manufacturing process of the storage device 100 or while it is in operation. The controller 120 may download new firmware from an external source, outside the confines of the storage device 100, and update the existing firmware with the new firmware.

To drive the controller 120, the working memory 125 may store necessary firmware, a program code, a command, and data. The working memory 125 may be a volatile memory that includes, for example, at least one from among an SRAM (static RAM), a DRAM (dynamic RAM), and an SDRAM (synchronous DRAM). Meanwhile, the controller 120 may additionally use a separate volatile memory (e.g., SRAM, or DRAM) located outside the controller 120 in addition to the working memory 125.

The error detection and correction circuit 126 may detect an error bit of target data, and correct the detected error bit by using an error correction code. The target data may be data stored in the working memory 125 or data read from the memory 110.

The error detection and correction circuit 126 may decode data by using an error correction code. The error detection and correction circuit 126 may be implemented using various code decoders. For example, a decoder that performs unsystematic code decoding or a decoder that performs systematic code decoding may be used.

For example, the error detection and correction circuit 126 may detect an error bit within each set sector of the read data when the read data is composed of a plurality of sectors. A sector may be a data unit smaller than a page, which serves as the read unit of a flash memory. The plurality of sectors constituting the read data may be matched with one another using addresses.

The error detection and correction circuit 126 may calculate a bit error rate (BER), and may determine whether an error is correctable or not on a sector-by-sector basis. For example, when a bit error rate is higher than a reference value, the error detection and correction circuit 126 may determine that a corresponding sector is uncorrectable or failed. On the other hand, when a bit error rate is lower than the reference value, the error detection and correction circuit 126 may determine that a corresponding sector is correctable or passed.

The error detection and correction circuit 126 may perform an error detection and correction operation sequentially for all read data. In the case where a sector included in read data is found to be correctable, the error detection and correction circuit 126 may skip the error detection and correction operation for the corresponding sector in the next set of read data. If the error detection and correction operation for all read data is completed in this manner, the error detection and correction circuit 126 may detect uncorrectable sectors in the last set of read data. There may be one or more sectors determined to be uncorrectable. The error detection and correction circuit 126 may transfer information (e.g., address information) regarding the uncorrectable sector(s) to the processor 124.

A bus 127 may be configured to provide channels among the components 121, 122, 124, 125, and 126 of the controller 120. The bus 127 may include a control bus for transferring various control signals, commands, and the like, a data bus for transferring various data, and so forth.

Some components among the above-described components 121, 122, 124, 125, and 126 of the controller 120 may be omitted, or some components among the above-described components 121, 122, 124, 125, and 126 of the controller 120 may be integrated into one component. In addition to the above-described components 121, 122, 124, 125, and 126 of the controller 120, one or more other components may be added.

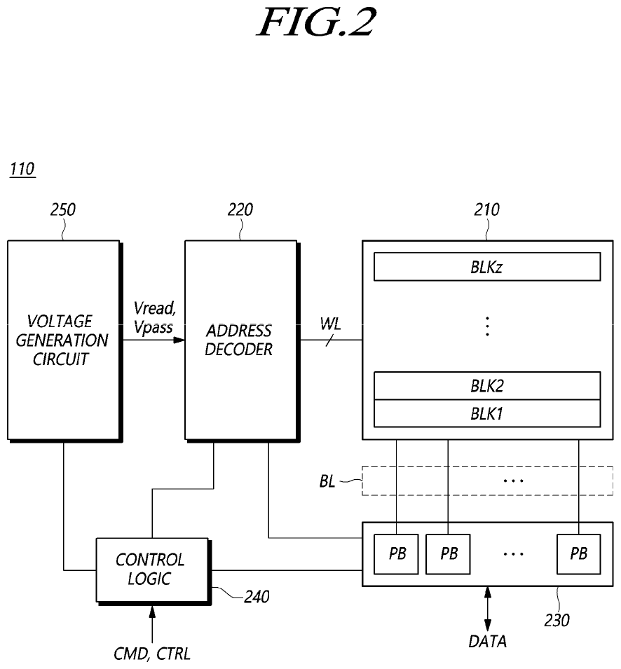

Hereinbelow, the memory 110 will be described in further detail with reference to FIG. 2.

FIG. 2 is a block diagram schematically illustrating the memory 110 of FIG. 1.

Referring to FIG. 2, the memory 110 may include a memory cell array 210, an address decoder 220, a read and write circuit 230, a control logic 240, and a voltage generation circuit 250.

The memory cell array 210 may include a plurality of memory blocks BLK1 to BLKz (where z is a natural number of 2 or greater).

In the plurality of memory blocks BLK1 to BLKz, a plurality of word lines WL and a plurality of bit lines BL may be disposed.

The plurality of memory blocks BLK1 to BLKz may be coupled to the address decoder 220 through the plurality of word lines WL. The plurality of memory blocks BLK1 to BLKz may be coupled to the read and write circuit 230 through the plurality of bit lines BL.

Each of the plurality of memory blocks BLK1 to BLKz may include a plurality of memory cells. For example, the plurality of memory cells may be nonvolatile memory cells, and may be configured by nonvolatile memory cells that have vertical channel structures.

The memory cell array 210 may be configured by a memory cell array of a two-dimensional structure or may be configured by a memory cell array of a three-dimensional structure.

Each of the plurality of memory cells included in the memory cell array 210 may store at least 1-bit data. For instance, each of the plurality of memory cells included in the memory cell array 210 may be a single level cell (SLC) that stores 1-bit data. In another instance, each of the plurality of memory cells included in the memory cell array 210 may be a multi-level cell (MLC) that stores 2-bit data. In still another instance, each of the plurality of memory cells included in the memory cell array 210 may be a triple level cell (TLC) that stores 3-bit data. In yet another instance, each of the plurality of memory cells included in the memory cell array 210 may be a quad level cell (QLC) that stores 4-bit data. In a further instance, the memory cell array 210 may include a plurality of memory cells, each of which stores 5 or more bits of data.

The number of bits of data stored in each of the plurality of memory cells may be dynamically determined. For example, a single-level cell that stores 1-bit data may be changed to a triple-level cell that stores 3-bit data.

Referring to FIG. 2, the address decoder 220, the read and write circuit 230, the control logic 240, and the voltage generation circuit 250 may operate as a peripheral circuit that drives the memory cell array 210.

The address decoder 220 may be coupled to the memory cell array 210 through the plurality of word lines WL.

The address decoder 220 may be configured to operate under the control of the control logic 240.

The address decoder 220 may receive an address through an input/output buffer in the memory 110. The address decoder 220 may be configured to decode a block address in the received address. The address decoder 220 may select at least one memory block depending on the decoded block address.

The address decoder 220 may receive a read voltage Vread and a pass voltage Vpass from the voltage generation circuit 250.

During a read operation, the address decoder 220 may apply the read voltage Vread to a selected word line WL coupled to a selected memory block, and may apply the pass voltage Vpass to the remaining unselected word lines WL coupled to the selected memory block.

During a program verify operation, the address decoder 220 may apply a verify voltage generated in the voltage generation circuit 250 to a selected word line WL coupled to a selected memory block, and may apply the pass voltage Vpass to the remaining unselected word lines WL coupled to the selected memory block.

The address decoder 220 may be configured to decode a column address in the received address. The address decoder 220 may transmit the decoded column address to the read and write circuit 230.

A read operation and a program operation of the memory 110 may be performed on a page-by-page basis. An address received when a read operation or a program operation is requested may include at least one from among a block address, a row address, and a column address.

The address decoder 220 may select one memory block and one word line based on a block address and a row address. A column address may be decoded by the address decoder 220 and be provided to the read and write circuit 230.

The address decoder 220 may include at least one from among a block decoder, a row decoder, a column decoder, and an address buffer.

The read and write circuit 230 may include a plurality of page buffers PB. The read and write circuit 230 may operate as a read circuit in a read operation of the memory cell array 210, and may operate as a write circuit in a write operation of the memory cell array 210.

The read and write circuit 230 described above may also be referred to as a page buffer circuit or a data register circuit that includes a plurality of page buffers PB. The read and write circuit 230 may include data buffers that take charge of a data processing function, and may further include cache buffers that take charge of a caching function.

The plurality of page buffers PB may be coupled to the memory cell array 210 through the plurality of bit lines BL. The plurality of page buffers PB may continuously supply sensing current to bit lines BL that are coupled to memory cells to sense threshold voltages (Vth) of the memory cells in a read operation and a program verify operation, and may latch sensed data by sensing, through sensing nodes, changes in the amounts of current flowing through the bit lines BL depending on programmed states of the memory cells.

The read and write circuit 230 may operate in response to page buffer control signals outputted from the control logic 240.

In a read operation, the read and write circuit 230 temporarily stores read data by sensing data of memory cells, and then, outputs data DATA to the input/output buffer of the memory 110. In an embodiment, the read and write circuit 230 may include a column select circuit in addition to the page buffers PB or the page registers.

The control logic 240 may be coupled to the address decoder 220, the read and write circuit 230, and the voltage generation circuit 250. The control logic 240 may receive a command CMD and a control signal CTRL through the input/output buffer of the memory 110.

The control logic 240 may be configured to control general operations of the memory 110 in response to the control signal CTRL. The control logic 240 may output control signals for adjusting the precharge potential levels of the sensing nodes of the plurality of page buffers PB.

The control logic 240 may control the read and write circuit 230 to perform a read operation of the memory cell array 210. The voltage generation circuit 250 may generate the read voltage Vread and the pass voltage Vpass used in a read operation, in response to a voltage generation circuit control signal output from the control logic 240.

Each memory block of the memory 110 described above may be configured with a plurality of pages corresponding to a plurality of word lines WL and a plurality of strings corresponding to a plurality of bit lines BL.

In a memory block BLK, a plurality of word lines WL and a plurality of bit lines BL may be disposed to intersect with each other. For example, each of the plurality of word lines WL may be disposed in a row direction, and each of the plurality of bit lines BL may be disposed in a column direction. Alternatively, each of the plurality of word lines WL may be disposed in a column direction, and each of the plurality of bit lines BL may be disposed in a row direction.

A memory cell may be coupled to one of the plurality of word lines WL and one of the plurality of bit lines BL. A transistor may be disposed in each memory cell.

For example, a transistor disposed in each memory cell may include a drain, a source, and a gate. The drain (or source) of the transistor may be coupled to a corresponding bit line BL either directly or via another transistor. The source (or drain) of the transistor may be coupled to a source line, which may be the ground, either directly or via another transistor. The gate of the transistor may include a floating gate, which is surrounded by a dielectric, and a control gate to which a gate voltage is applied from a word line WL.

In each memory block, a first select line (also referred to as a source select line or a drain select line) may be additionally disposed outside a first outermost word line, which is closer to the read and write circuit 230, between two outermost word lines, and a second select line (also referred to as a drain select line or a source select line) may be additionally disposed outside a second outermost word line between the two outermost word lines.

At least one dummy word line may be disposed between the first outermost word line and the first select line. In addition, at least one dummy word line may be disposed between the second outermost word line and the second select line.

A read operation and a program operation (or write operation) of the memory block described above may be performed on a page-by-page basis, and an erase operation may be performed on a memory block basis.

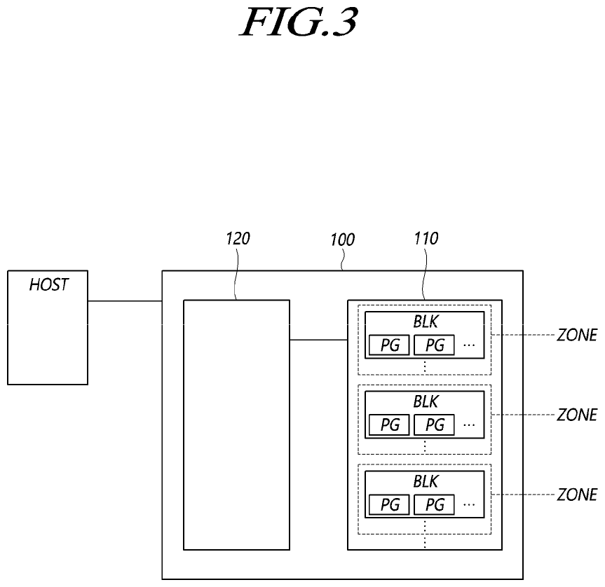

FIG. 3 shows a schematic structure of a storage device 100 according to an embodiment of the disclosed technology.

Referring to FIG. 3, the storage device 100 may include a memory 110 and a controller 120.

The memory 110 may include a plurality of memory blocks BLK. Each of a plurality of zones ZONE may include one or more memory blocks BLK. Data stored in each zone ZONE may be managed in a block mapping scheme.

Each of the plurality of memory blocks BLK may include a plurality of pages PG.

The plurality of zones ZONE may be managed by a host HOST which is connected to the storage device 100. The host HOST may request, to the storage device 100, an operation of creating the plurality of zones ZONE, an operation of writing data to the plurality of zones ZONE, and an operation of deleting or resetting some of the plurality of zones ZONE.

When writing data to one zone ZONE among the plurality of zones ZONE, the host HOST may sequentially write the data to the corresponding zone ZONE. In such a case, data already stored in the corresponding zone ZONE is not updated. To this end, the host HOST may manage, for each of the plurality of zones ZONE, a write pointer indicating the location where data is to be written in each zone ZONE.

Once the host HOST fully uses the storage capacity of a specific zone ZONE, indicated by a write pointer reaching the end of the specific zone ZONE, all memory blocks mapped to the specific zone ZONE are completely filled with data. In this case, since there is no available space in the specific zone ZONE where data is neither stored nor wasted, the host HOST can use the specific zone ZONE efficiently.

The controller 120 may set the plurality of zones ZONE according to a request of the host HOST. Each of the plurality of zones ZONE may include at least one among the plurality of memory blocks BLK included in the memory 110.

The controller 120 may control a write operation for the memory 110, and may write data to one zone ZONE among the plurality of zones ZONE according to a request of the host HOST.

While the storage device 100 writes data to one zone ZONE among the plurality of zones ZONE according to the request of the host HOST, a sudden power-off, in which power supply is abnormally suspended, may occur. Hereinafter, this will be described in detail.

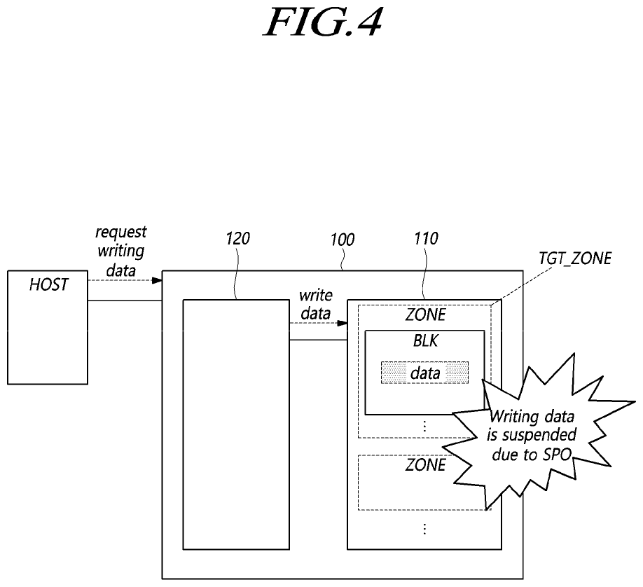

FIG. 4 is a diagram showing an operation of detecting a sudden power-off according to an embodiment of the disclosed technology. This operation may be performed by the storage device 100 described above with reference to FIG. 3.

Referring to FIG. 4, the storage device 100 may receive a request from the host HOST, instructing it to write data to a target zone TGT_ZONE among the plurality of zones ZONE, and subsequently, may write the data to the target zone TGT_ZONE in response to the request.

In FIG. 4, while performing the operation of writing the data to the target zone TGT_ZONE, the storage device 100 may detect the occurrence of a sudden power-off (SPO). This detection may assess SPO has occurred when the supplied power level falls below a reference level for a duration equal to or exceeding a reference time.

Upon detection of the sudden power-off, the operation of writing the data to the target zone TGT_ZONE is suspended, leading to a potential failure in the integrity of data stored in the target zone TGT_ZONE.

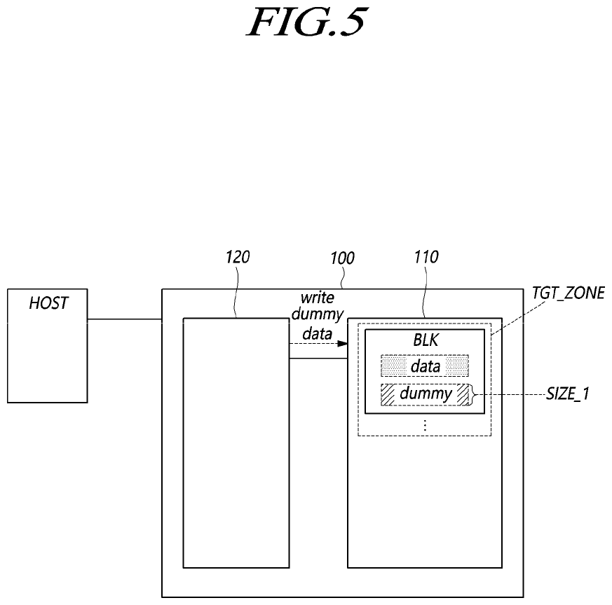

When power supply is restored after the occurrence of the sudden power-off, the storage device 100 may perform a recovery operation specific to the sudden power-off. By performing the recovery operation, the storage device 100 may address the failure that occurred in the memory 110 due to the sudden power-off, and may mitigate the potential for future failures in the memory 110. Hereinafter, this will be described in detail with reference to FIG. 5.

FIG. 5 is a diagram showing an operation of writing dummy data as part of a recovery operation tailored for addressing a sudden power-off according to an embodiment of the disclosed technology.

Referring to FIG. 5, upon the restoration of power following a sudden power-off, the controller 120 of the storage device 100 may write dummy data to the target zone TGT_ZONE. The size of the dummy data may be a first size SIZE_1.

To this end, the controller 120 may search for a page, which was last in use at the time of the sudden power-off, among memory blocks included in the target zone TGT_ZONE. The controller 120 may check whether an uncorrectable error correction code (UECC) has occurred in pages falling within a predetermined range from the searched page, and may write the dummy data to the corresponding pages so as to enhance the reliability of the target zone TGT_ZONE.

Since writing the dummy data to the memory 110 is controlled by the controller 120, a section of a memory block storing the dummy data is not accessed by the host HOST. Therefore, it is possible to prevent the host HOST from accessing a region afflicted by failures stemming from the sudden power-off.

In the embodiment of the disclosed technology, the dummy data may have various patterns. For example, the dummy data may be a repetitive sequence of a specific bit pattern. Alternatively, the dummy data may have random bit values.

The first size SIZE_1 may be a preset value. For example, the first size SIZE_1 may be a multiple of the size of a page included in each of the plurality of memory blocks BLK.

In this way, when the dummy data is written to the target zone TGT_ZONE upon the occurrence of the sudden power-off, there is potential for a mismatch between a write pointer managed by the host HOST for the target zone TGT_ZONE and the size of data which is actually stored in the target zone TGT_ZONE.

As described above, the controller 120 autonomously writes the dummy data without any request from the host HOST. Therefore, despite the writing of dummy data, the host HOST does not change the write pointer for the target zone TGT_ZONE. In this case, although the write pointer for the target zone TGT_ZONE remains unchanged, the size of data stored in the target zone TGT_ZONE increases.

Consequently, when the host HOST writes data of a predetermined size to the target zone TGT_ZONE, an empty space, i.e., an unoccupied space, where data is not stored, may occur in a memory block where data was last written within the target zone TGT_ZONE. This could lead to degradation in the performance of the target zone TGT_ZONE.

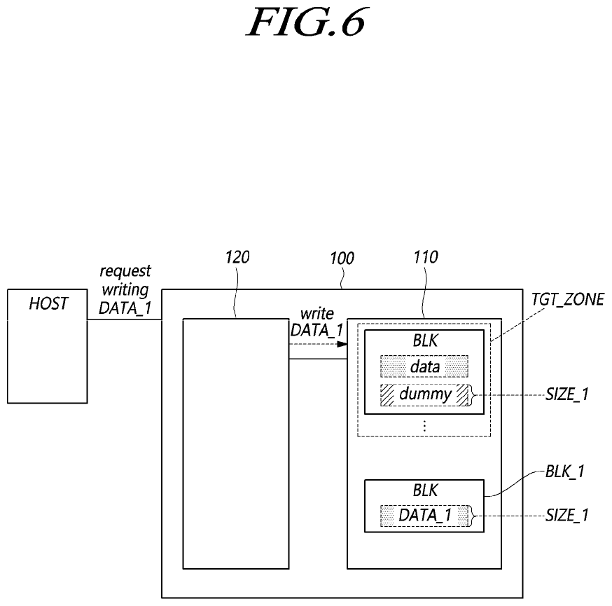

Therefore, it becomes imperative for the storage device 100 to address the mismatch issue arising from the writing of dummy data. Hereinafter, this will be described in detail with reference to FIG. 6.

FIG. 6 is a diagram showing an operation of writing first data DATA_1 according to an embodiment of the disclosed technology.

After the dummy data is written to the target zone TGT_ZONE, the controller 120 of the storage device 100 may receive a write request for the target zone TGT_ZONE from the host HOST. Referring to FIG. 6, the controller 120 may receive a write request from the host HOST, instructing it to write the first data DATA_1 to the target zone TGT_ZONE. The first data DATA_1 may include the entire set or a portion of data requested for writing by the host HOST.

At this moment, the target zone TGT_ZONE may be in a state where no additional data is expected to be written after the previously mentioned insertion of dummy data. That is, the target zone TGT_ZONE may be full of data.

The host HOST may transmit the write request, which instructs the writing of the first data DATA_1 to the target zone TGT_ZONE, to the controller 120 in various manners.

For example, the host HOST may divide a write request into a plurality of write commands, and may transmit the plurality of write commands to the controller 120.

Alternatively, the host HOST may transmit, to the controller 120, a write request including the first data DATA_1.

In response to the write request, the controller 120 may write the first data DATA_1 to a designated memory block, which is distinct from those included in the target zone TGT_ZONE, among the plurality of memory blocks BLK.

In FIG. 6, the designated memory block may be a first memory block BLK_1. The controller 120 may write the first data DATA_1 to the first memory block BLK_1. The first memory block BLK_1 may be selected from among memory blocks BLK, which are not part of the target zone TGT_ZONE, among the plurality of memory blocks BLK.

For example, the first memory block BLK_1 may be a backup memory block which is not included in any zone ZONE among the plurality of zones ZONE.

The size of the first data DATA_1 may be the first size SIZE_1 that is a size corresponding to the dummy data.

In this way, when the controller 120 writes the first data DATA_1 to the first memory block BLK_1, the controller 120 may effectively address the mismatch between the write pointer managed by the hose HOST for the target zone TGT_ZONE and the size of data which is actually written to the target zone TGT_ZONE. This proactive measure may prevent the degradation of performance in the target zone TGT_ZONE.

When the first data DATA_1 is written to the first memory block BLK_1 in this manner, the storage device 100 should generate mapping information allowing the host HOST to access the first data DATA_1. This arises because, although the host HOST seeks to write the first data DATA_1 to the target zone TGT_ZONE, the first memory block BLK_1, where the first data DATA_1 is actually written, is not part of the target zone TGT_ZONE.

Hereinafter, a specific embodiment of generating mapping information will be described.

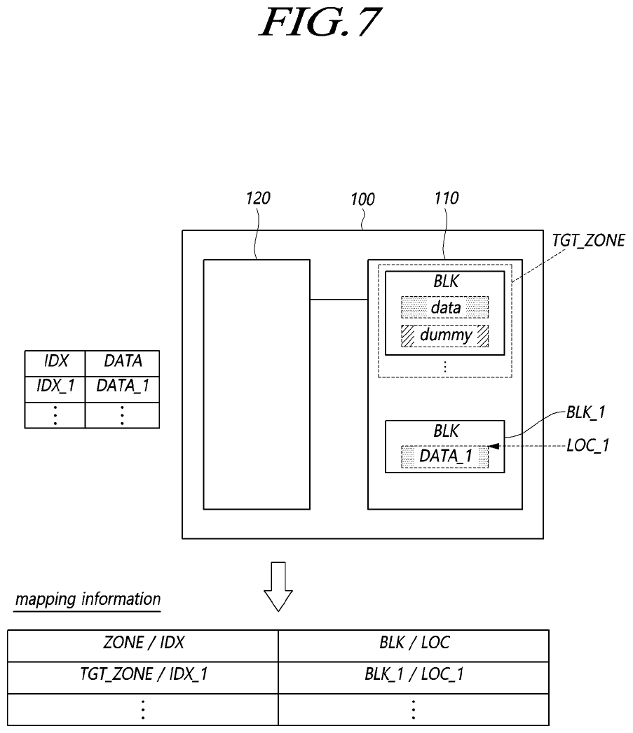

FIG. 7 is a diagram showing an operation of generating mapping information according an embodiment of the disclosed technology.

Referring to FIG. 7, the controller 120 of the storage device 100 may generate mapping information indicating the mapping relationship between an index corresponding to the first data DATA_1 within the target zone TGT_ZONE and a location where the first data DATA_1 is actually stored within the first memory block BLK_1.

The index corresponding to the first data DATA_1 may indicate the relative location of the first data DATA_1 within the target zone TGT_ZONE.

The location where the first data DATA_1 is actually stored within the first memory block BLK_1 may indicate a physical location (e.g., an address of a page) where the first data DATA_1 is actually stored.

In FIG. 7, the index corresponding to the first data DATA_1 within the target zone TGT_ZONE is IDX_1. The location where the first data DATA_1 is actually stored within the first memory block BLK_1 is LOC_1.

Accordingly, the controller 120 may generate the mapping information indicating that the index IDX_1 corresponding to the first data DATA_1 within the target zone TGT_ZONE and the location LOC_1 where the first data DATA_1 is actually stored within the first memory block BLK_1 are mapped to each other.

The index IDX_1 corresponding to the first data DATA_1 within the target zone TGT_ZONE and the location LOC_1 where the first data DATA_1 is actually stored within the first memory block BLK_1 may be mapped in units of the first size SIZE_1, which represents the size of the first data DATA_1.

The mapping information may additionally include flag information indicating that the first data DATA_1 is stored in the first memory block BLK_1. Utilizing the flag information, the controller 120 can discern that the first data DATA_1 is not stored in a memory block within the target zone TGT_ZONE and instead, is stored in the first memory block BLK_1, which is outside the confines of the target zone TGT_ZONE.

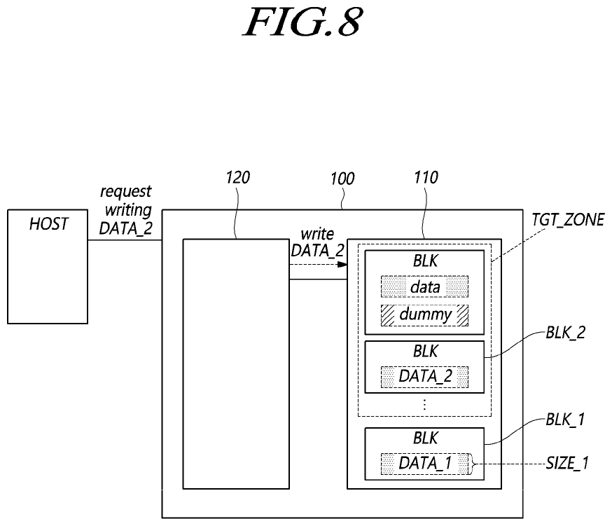

FIG. 8 is a diagram showing an operation of writing second data DATA_2 according to an embodiment of the disclosed technology.

Referring to FIG. 8, the controller 120 of the storage device 100 may write additional data to the target zone TGT_ZONE after the completion of writing the first data DATA_1 to the first memory block BLK_1. For example, the controller 120 may write second data DATA_2 to the target zone TGT_ZONE.

For example, the controller 120 may simultaneously receive requests from the host HOST instructing the writing of both the first data DATA_1 and the second data DATA_2. Alternatively, the controller 120 may first receive a request from the host HOST instructing the writing of the first data DATA_1, and then, may receive a separate request from the host HOST instructing the writing of the second data DATA_2.

The controller 120 may write the second data DATA_2 to a memory block within the target zone TGT_ZONE among the plurality of memory blocks BLK. In FIG. 8, the controller 120 may write the second data DATA_2 to a second memory block BLK_2 within the target zone TGT_ZONE.

Since the above-mentioned mismatch issue is solved by writing the first data DATA_1 to the first memory block BLK_1, the controller 120 can write the second data DATA_2 onto the target zone TGT_ZONE.

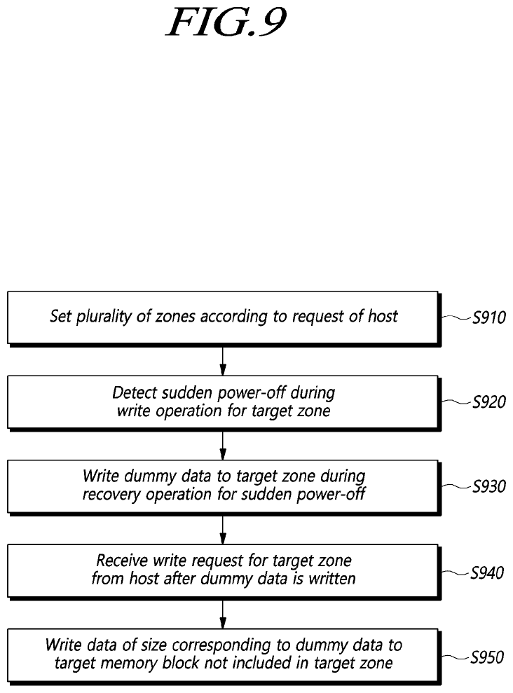

FIG. 9 is a diagram showing a method for operating a storage device according an embodiment of the disclosed technology. The method will be described with reference to FIGS. 3 to 7.

Referring to FIG. 9, at S910, the storage device 100 may set the plurality of zones ZONE according to a request of the host HOST. As described above, the memory 110 may include the plurality of memory blocks BLK, and each of the plurality of zones ZONE may include one or more of the plurality of memory blocks BLK.

At S920, the storage device 100 may detect a sudden power-off in which the power supply is abruptly cut off during a write operation for the target zone TGT_ZONE among the plurality of zones ZONE.

At S930, the storage device 100 may write dummy data to the target zone TGT_ZONE during a recovery operation for the sudden power-off.

At S940, the storage device 100 may receive, from the host HOST, a write request for the target zone TGT_ZONE after the dummy data is written to the target zone TGT_ZONE.

At S950, the storage device 100 may write data of a size matching that of the dummy data onto a target memory block, which is outside the target zone TGT_ZONE, among the plurality of memory blocks BLK, in response to the write request for the target zone TGT_ZONE.

For example, the step S950 may include generating mapping information. The mapping information indicates the mapping relationship between an index corresponding to the data within the target zone TGT_ZONE and a specific location where the data is stored within the target memory block.

The mapping information may additionally include flag information indicating that the data is actually stored in the target memory block.

The index corresponding to the data within the target zone TGT_ZONE and the specific location where the data is stored within the target memory block may be mapped in units of the size of the data.

The method may further include writing additional data to the target zone TGT_ZONE after the completion of writing the data to the target memory block. For example, the additional data is written to a memory block within the target zone TGT_ZONE among the plurality of memory blocks BLK.

Although exemplary embodiments of the disclosure have been described for illustrative purposes, those skilled in the art will appreciate that various modifications, additions and substitutions are possible, without departing from the scope and spirit of the disclosure. Therefore, the embodiments disclosed above and in the accompanying drawings should be considered in a descriptive sense only and not for limiting the technological scope. The technological scope of the disclosure is not limited by the embodiments and the accompanying drawings. The spirit and scope of the disclosure should be interpreted in connection with the appended claims and encompass all equivalents falling within the scope of the appended claims.

What is claimed is:

1. A storage device comprising:
a memory including a plurality of memory blocks, each of the plurality of memory blocks including a plurality of pages; and
a controller configured to:
set a plurality of zones, each of which includes one or more memory blocks among the plurality of memory blocks, according to a request of a host,
when a sudden power-off is detected during a writing operation for a target zone among the plurality of zones, write dummy data to the target zone during a recovery operation for the sudden power-off, and
in response to a write request from the host for the target zone after the dummy data is written to the target zone, write data of a size matching that of the dummy data onto a target memory block, which is outside the target zone among the plurality of memory blocks.

2. The storage device according to claim 1, wherein the size of the data is a multiple of a size of a page.

3. The storage device according to claim 1, wherein when writing the data to the target memory block, the controller generates mapping information indicating a mapping relationship between an index corresponding to the data within the target zone and a location where the data is stored within the target memory block.

4. The storage device according to claim 3, wherein the mapping information includes flag information indicating that the data is stored in the target memory block.

5. The storage device according to claim 3, wherein the index corresponding to the data within the target zone and the location where the data is stored in the target memory block are mapped by units of the size of the data.

6. The storage device according to claim 1, wherein when writing additional data to the target zone after writing the data to the target memory block, the controller writes the additional data to a memory block included in the target zone.

7. A method for operating a storage device, the method comprising:
setting a plurality of zones according to a request of a host, each of the plurality of zones including one or more memory blocks among a plurality of memory blocks included in the storage device;
detecting a sudden power-off during a writing operation for a target zone among the plurality of zones;
writing dummy data to the target zone during a recovery operation for the sudden power-off;
receiving, from the host, a write request for the target zone after the dummy data is written to the target zone; and
writing, in response to the write request, data of a size matching that of the dummy data onto a target memory block, which is outside the target zone among the plurality of memory blocks.

8. The method according to claim 7, wherein the writing of the data onto the target memory block comprises:
generating mapping information indicating a mapping relationship between an index corresponding to the data within the target zone and a location where the data is stored within the target memory block.

9. The method according to claim 8, wherein the mapping information includes flag information indicating that the data is stored within the target memory block.

10. The method according to claim 8, wherein the index corresponding to the data within the target zone and the location where the data is stored within the target memory block are mapped by units of the size of the data.

11. The method according to claim 7, further comprising:
when writing additional data to the target zone after writing the data to the target memory block, writing the additional data to a memory block included in the target zone.
